(19) United States
(12) Patent Application Publication
(10) Pub. No.: US 2026/0093703 A1
(43) Pub. Date: Apr. 2, 2026

(54) 1-HOP SUB-QUERY RESULT CACHES FOR GRAPH DATABASES

(71) Applicants: eBay Inc., San Jose, CA (US); University of Southern California, Los Angeles, CA (US)

(72) Inventors: Hieu Trung NGUYEN, San Jose, CA (US); Shahram GHANDEHARIZADEH, Los Angeles, CA (US); Jun LI, Mountain View, CA (US)

(21) Appl. No.: 19/009,020

(22) Filed: Jan. 3, 2025

Related U.S. Application Data
(60) Provisional application No. 63/699,909, filed on Sep. 27, 2024.

(51) Int. Cl. G06F 16/2455

(52) U.S. Cl. CPC G06F 16/24552

(57) ABSTRACT

Some aspects relate to technologies for graph databases with 1-hop sub-query result caching. In accordance with some aspects, cache entries are generated that comprise key-value pairs, each having a cache key based on a vertex identifier of a vertex from a 1-hop sub-query instance and a value based on results of a 1-hop graph traversal from the vertex based on the 1-hop sub-query instance. A cache key can also be based on a property value of a predicate from a 1-hop sub-query instance. During graph query processing, a 1-hop sub-query instance is obtained based on the graph query. A cache key is generated using a vertex identifier for the vertex from the 1-hop sub-query instance. A lookup is performed in the cache data using the cache key, and an output is provided using one or more leaf vertex identifiers from a value of a cache entry having the cache key.

### CROSS-REFERENCE TO RELATED APPLICATIONS

This application claims the benefit of U.S. Provisional Application No. 63/699,909, filed Sep. 27, 2024, which is herein incorporated by reference in its entirety.

### BACKGROUND

Graph database systems are used by diverse applications, ranging from cybersecurity monitoring to fraud detection, link prediction, search, and product recommendation, to name a few. Typically, graph database systems represent data as a property graph that includes vertices (also known as nodes), edges, labels, and/or properties. Vertices represent entities. Edges represent connections between vertices and can be undirected or directed, either going out or into a vertex when directed. Properties are information added to the vertices and edges that are often in the form of attribute-value pairs. Vertices and edges can also have labels that identify and group similar types of vertices or edges.

To process a graph query, a graph database system performs a traversal on the graph data. A graph traversal can include a sequence of operations that describe how to navigate a graph. An operation can apply a predicate to labels and properties of the vertices and edges. An operation can start by identifying a root vertex (also referred to as a start vertex). The operation can use predicates to identify relevant edges of the root vertex (incoming or outgoing in the case of a directed graph) and relevant resulting vertices connected by those edges. For instance, the operation can apply a predicate to labels and/or properties of the edges and prune down the resulting vertices by applying a predicate to their labels and/or properties. The result of such an operation is a set of leaf vertex identifiers. The next operation in the traversal can use each of these vertex identifiers as a root vertex to perform the next hop. This can be repeated multiple times until all operations are processed. The graph database system can use set operators, such as union, to combine the set of vertices. With the final set of vertices, in some cases, the graph database system can enumerate a specific property value or apply aggregate functions, such as count and group-by. The final output of the graph query can be a list of vertices, edges, properties, and/or any other data extracted from the graph data based on the operations.

### SUMMARY

Some aspects of the present technology relate to, among other things, a graph database system that employs 1-hop sub-query result caching. In accordance with some aspects of the technology described herein, a graph database system includes cache data with cache entries that cache results of 1-hop sub-query instances. A 1-hop sub-query instance comprises a 1-hop graph traversal from a root vertex and can include parameters, such as predicates on edge properties and leaf vertex properties. A cache entry for a 1-hop sub-query instance comprises a key-value pair. The cache key of the key-value pair is generated based on at least the vertex identifier of the root vertex, but can also include other parameters from the 1-hop sub-query instance. For instance, the cache key for a 1-hop sub-hop query instance having a predicate on an edge property or a leaf vertex property can also be generated using a property value from the predicate. In some configurations, 1-hop sub-query instances are generated using sub-query templates, and the cache keys can include a query template identifier. The value of the key-value pair comprises the results of performing the 1-hop sub-query instance on the graph data, which can be a set of leaf vertex identifiers.

When processing a graph query, the graph query is analyzed to identify a sub-query or a sequence of sub-queries that are processed in the order of the sequence. For a sub-query of the graph query that comprises a 1-hop sub-query instance, a cache key is generated using a root vertex identifier and, in some cases, parameters of the sub-query. The root vertex can be specified by the sub-query or could be provided as a result from a previous sub-query in the graph query. A lookup is performed on the cache data using the cache key. When there is a cache hit, the value of the cache entry is used to obtain a set of leaf vertex identifiers. Where there is a cache miss, the 1-hop sub-query instance is processed using the graph data to obtain a set of leaf vertex identifiers. After processing each sub-query of the graph query, the graph database system provides an output as a response to the graph query.

Further aspects of the present technology are directed to adding new cache entries and modifying cache data based on graph updates. In some configurations, transactional caching is employed. Transactional caching in some aspects involves performing operations to add a new cache entry as a single transaction. Transactional caching in some other aspects involves performing operations to modify both cache data and graph data based on graph updates as a single transaction.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram showing an example 1-hop sub-query instance in accordance with some implementations of the present disclosure;

FIG. 3 is a block diagram showing an example implementation of graph database system with 1-hop cache data in accordance with some implementations of the present disclosure;

FIG. 4 is a block diagram showing the life-cycle of a sub-query template in accordance with some implementations of the present disclosure;

FIG. 5 is a flow diagram showing a method for processing a graph query in accordance with some implementations of the present disclosure;

FIG. 6 is a flow diagram showing a method for processing a 1-hop sub-query instance from a graph query in accordance with some implementations of the present disclosure;

FIG. 7 is a flow diagram showing a method for adding a cache entry for a 1-hop sub-query instance to cache data in accordance with some implementations of the present disclosure;

FIG. 8 is a flow diagram showing a method for updating cache data based on a graph update in accordance with some implementations of the present disclosure; and

FIG. 9 is a block diagram of an exemplary computing environment suitable for use in implementations of the present disclosure.

### DETAILED DESCRIPTION

### Overview

Low query latency is a critical for a graph database. However, using conventional query databases, high latencies are observed for processing some graph queries. High latency is a particular problem when dealing with complex graph queries that involve a large amount of data, such as when the graph queries require examining a large number of vertices or edges. For instance, a graph query can involve multiple hops to traverse the graph, and each hop could require the examination of a large number of connected vertices and edges. This is particularly problematic when dealing with supernodes (also referred to as high fan-out vertices), which are vertices that have a very large number of edges.

As an example to illustrate, the graph database for a social network platform may include vertices representing users. Edges from a vertex for a user can represent connections to vertices for followers of that user on the social network platform. While most users typically have a relatively manageable number of followers, some users, such as celebrities, have hundreds of millions of followers. The vertices for those celebrities therefore have several hundred million edges. A graph query that includes such a supernode will require examining those several hundred million edges and possibly the several hundred million vertices connected to those edges, as well as edges from those vertices, resulting in very high latency. In some cases, a graph query could involve multiple supernodes, which further exacerbates the latency issue.

In addition to high latency, performance of these graph queries results in the consumption of a large amount of computer resources, such as the number of reads on the graph data to perform the graph queries. This presents a number of problems, such as wear on physical computer components (e.g., hard disk drives) and negatively impacting the latency of other graph queries being processed by the graph database.

One potential approach for addressing this high latency is to cache results for graph queries. In a mixed read/write environment, cached results need to be invalidated when writes change graph structure or graph elements. The more aggressive graph query results are cached, the more complex to determine change impact and thereafter to invalidate impacted cache entries. Further, strong consistency between graph update and cache invalidation is needed to ensure correctness of query results returned in response to graph queries. In a distributed environment involving many graph query executors, strong consistency on cache data with the graph data is difficult to achieve using current caching approaches.

Aspects of the technology described herein improve the functioning of query databases in light of these shortcomings in existing query databases by providing a solution that uses 1-hop sub-query result caching. In accordance with some aspects, query results are cached for 1-hop sub-query instances. A 1-hop sub-query instance corresponds to a 1-hop graph traversal from a root vertex (or start vertex) that can include other parameters, such as predicates on edge properties and/or leaf vertex properties. A cache entry for a 1-hop sub-query instance comprises a key-value pair. The cache key for a key-value pair is based at least on the vertex identifier for the root vertex. The cache key can also be based on other parameters, such as property values of predicates in the 1-hop sub-query instance. In some configurations, 1-hop sub-query instances are generated using sub-query templates, and the cache key for a 1-hop sub-query instance can include a sub-query template identifier for the sub-query template used to generate the 1-hop sub-query instance. The value for the key-value pair is based on a set of leaf vertex identifiers returned from the graph data by processing the 1-hop sub-query instance. In some cases, the leaf vertex identifiers can be serialized and/or compressed to generate the value.

When processing a graph query, the graph database system analyzes the graph query to identify at least one sub-query that comprises a 1-hop sub-query instance. For some graph queries, a sequence of sub-queries is identified, with each sub-query corresponding to a different portion of the graph query. The sub-queries of such graph queries are processed in that sequence, such that results from one sub-query can be used when processing a subsequent sub-query in the sequence.

For a given 1-hop sub-query instance from the graph query, the graph database system generates a cache key based at least on a root vertex identifier, and in some cases, based on parameters of the 1-hop sub-query instance. A lookup is performed on the cache data to determine if there is a cache entry having that cache key. If a cache entry with the cache key is present (i.e., a cache hit), a set of leaf vertex identifiers are returned from the value of that cache entry. This could include deserializing and/or decompressing the value. If a cache entry with the cache key is missing (i.e., a cache miss), the graph database system processes the 1-hop sub-query instance using the graph data to return a set of vertex identifiers. After processing each sub-query, the query database system provides an output as a response to the graph query.

When a cache miss occurs for a 1-hop sub-query instance from a graph query, a new cache entry can be added to the cache data for that 1-hop sub-query instance. The addition of the new cache entry can be synchronous with processing the 1-hop sub-query instance using the graph data. However, synchronous caching can negatively impact performance of the graph query. Accordingly, in some aspects asynchronous caching is used in which a 1-hop sub-query instance from a cache miss is added as a cache populate job in a queue and processed by the graph based base system in the background.

Some aspects of the technology described herein also address modifying cache data based on graph updates. A variety of different types of graph updates can be performed, such as adding/changing/deleting edges and adding/changing/deleting vertices. When a graph update is received, impacted cache keys are generated based on the graph update. In some configurations, the generation of impacted cache keys is based on the type of graph update. The impacted cache entries for those impacted cache keys are then modified based on the graph update. This could include invalidating an impacted cache entry or refilling an impacted cache entry.

In some further aspects, transactional caching is employed. A transaction involves operations in which either all changes are committed or none are committed. This ensures compliance with ACID (atomic, consistent, isolated, and durable) principles, including ensuring consistency between the graph data and the cache data. In some aspects, when adding a new cache entry for configurations using transaction caching, the operations to add the cache entry are performed as a single transaction. In some aspects, when modifying cache data based on a graph update for configurations using transactional caching, the operations to both modify the cache data and update the graph data are performed as a single transaction.

Aspects of the technology described herein provide a number of improvements over existing graph databases. For instance, the technology described herein provides a cache for 1-hop sub-query instances that minimizes the amount of data and processing required by a 1-hop sub-query. For instance, a cache hit reduces two network round trips to process a 1-hop sub-query into one network round-trip to lookup the result of the 1-hop sub-query in the cache. An unexpected result of this cache approach is that it provides significant performance gains observed by the indirect beneficiaries of the cache, i.e., write and reads that do not reference a 1-hop sub-query. The cache frees computer resources for use by writes and queries that do not use the cache to enhance performance of such operations. In some configurations, query re-writing combined with the cache further enhances performance. Test evaluations using production workloads show that the technology described herein enhanced the 95th and 99th response time significantly for reads (2.2× and 3.9×, after query rewriting). Additionally, the performance of both writes and queries that do not consist of 1-hop sub-queries was also enhanced, 1.3×-2.1× and 1.47×-11.75×, respectively.

Employing 1-hop sub-query result caching also reduces issues with modifying the cache data, for instance when performing graph updates, relative to caching results for entire graph queries. Additionally, 1-hop sub-query result caching improves the ability to maintain consistency between cache data and query data. Moreover, configurations of the present technology using transactional caching not only improve latency and computer resource consumption but also further preserve ACID principles, ensuring consistency between the cache data and the graph data. This can be important for applications that do not tolerate either stale or inconsistent query results. Additionally, configurations using asynchronous caching for cache misses enhance performance of reads relative to synchronous caching in two ways. First, it removes populating the cache from the processing path of the read. Second, it prevents a read from becoming a read-write, utilizing the read path of the storage manager, which can be faster than the write path.

Example Systems for Graph Databases with 1-Hop Sub-Query Caching

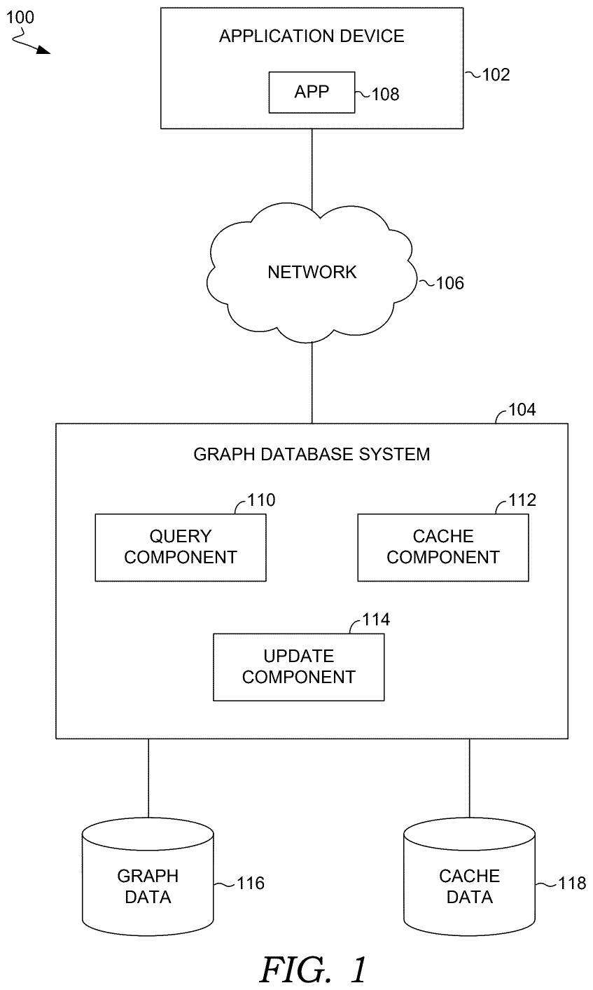

With reference now to the drawings, FIG. 1 is a block diagram illustrating an exemplary system 100 for a graph database system using 1-hop sub-query result caching in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

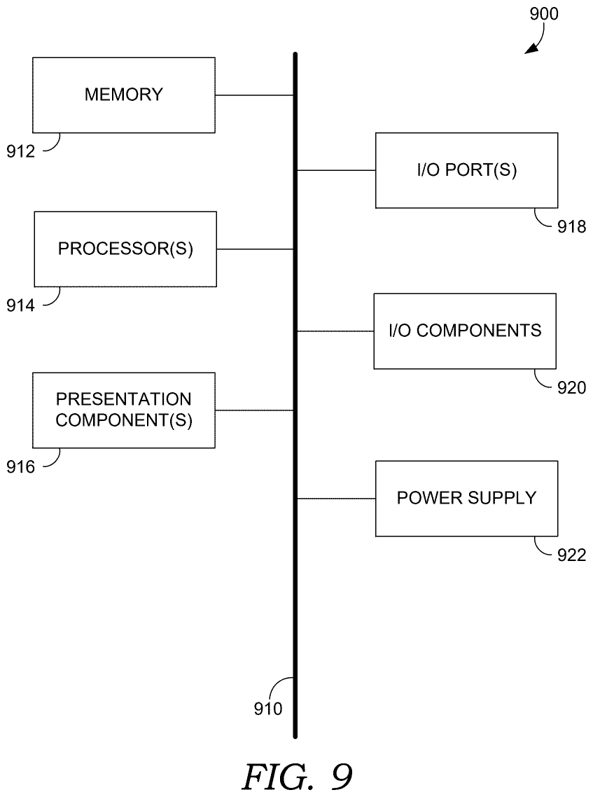

The system 100 is an example of a suitable architecture for implementing certain aspects of the present disclosure. Among other components not shown, the system 100 includes an application device 102 and a graph database system 104. Each of the application device 102 and the graph database system 104 shown in FIG. 1 can comprise one or more computer devices, such as the computing device 900 of FIG. 9, discussed below. As shown in FIG. 1, the application device 102 and the graph database system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of application devices and graph database systems can be employed within the system 100 within the scope of the present technology. Each can comprise a single device or multiple devices cooperating in a distributed environment. For instance, the graph database system 104 could be provided by multiple server devices collectively providing the functionality of the graph database system 104 as described herein. Additionally, other components not shown can also be included within the network environment.

In some configurations, the application device 102 can be a client device on the client-side of operating environment 100, while the graph database system 104 can be on the server-side of operating environment 100. The graph database system 104 can comprise server-side software designed to work in conjunction with client-side software on the application device 102 so as to implement any combination of the features and functionalities discussed in the present disclosure. For instance, the application device 102 can include an application 108 that interacts with the graph database system 104. The application 108 can be, for instance, a web browser or a dedicated application for providing certain functions for submitting queries to the graph database system 104 and processing output returned from the graph database system 104. This division of operating environment 100 is provided to illustrate one example of a suitable environment, and there is no requirement for each implementation that any combination of the application device 102 and the graph database system 104 remain as separate entities. While the operating environment 100 illustrates a configuration in a networked environment with a separate application device and graph database system, it should be understood that other configurations can be employed in which components are combined. For instance, in some configurations, a single device or group of devices can provide the functions of the application device 102 and the graph database system 104.

The application device 102 can comprise any type of computing device (such as the computing device 900 described in relation to FIG. 9 herein) capable of submitting queries to and receiving results from the graphs database system. For instance, in some aspects, the application device 102 can be an application server (operating as a client of the graph database system 104) with a software framework that provides an environment for running and managing applications, such as the application 108. In some other aspects, the application device 102 can be a user device associated with a user. By way of example and not limitation, the application device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user may or may not be associated with the application device 102 and can interact with the graph database system 104 via the application device 102.

The graph database system 104 provides a platform for returning results to graph queries based on graph data. As shown in FIG. 1, the graph database system 104 includes a query component 110, a cache component 112, and an update component 114. The components of the graph database system 104 can be in addition to other components that provide further additional functions beyond the features described herein. The graph database system 104 can be implemented using one or more server devices, one or more platforms with corresponding application programming interfaces, cloud infrastructure, and the like. While the graph database system 104 is shown separate from the application device 102 in the configuration of FIG. 1, it should be understood that in other configurations, some or all of the functions of the graph database system 104 can be provided on the application device 102.

In one aspect, the functions performed by components of the graph database system 104 are associated with one or more applications, services, or routines. In particular, such applications, services, or routines can operate on one or more devices, can be distributed across multiple devices, or can be implemented in the cloud. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The graph database system 104 performs operations to manage and query graph data and cache data. In particular, the graph data store 116 stores graph data represented as a property graph, which includes vertices (also known as nodes), edges, labels, and/or properties. Vertices represent entities and are identified using vertex identifiers. Edges represent connections between vertices and can be undirected or directed, either going out or into a vertex when directed. Properties are information added to the vertices and edges that can be in the form of attribute-value pairs. Vertices and edges can also have labels that identify and group similar types of vertices or edges. Properties and labels of edges and vertices can be immutable or mutable, while vertex identifiers are typically immutable.

The cache data store 118 stores cache data derived from the graph data. In accordance with the technology described herein, the cache data includes cache entries, each corresponding to a 1-hop sub-query instance. A 1-hop sub-query instance consumes one root vertex identifier to output a set of leaf vertex identifiers. A 1-hop sub-query instance can navigate either the root vertex's incoming or outgoing edges by applying one or more predicates to the property values and/or labels of these edges. A 1-hop sub-query instance can also qualify a leaf vertex by applying one or more predicates to the leaf vertex property values and/or labels. A set of leaf vertex identifiers is the output of a 1-hop sub-query instance. The number of leaf vertex identifiers in the set is the cardinality of the 1-hop sub-query instance and can range from zero (output is an empty set) to a large value (output of a super-node with many qualifying edges and leaf vertices).

In some aspects, 1-hop sub-query instances are generated using sub-query templates. A sub-query template identifies the structure for 1-hop sub-query instances that are cached. In some configurations, a sub-query instance must match a sub-query template in order for it to be cached. Otherwise, the sub-query instance is not cached and writes will not invalidate or refill its cache entry.

A sub-query template can specify, for instance, any number of parameters, such as edge properties and vertex properties. A sub-query template can specify values for properties or can use placeholders, such as wildcard characters (e.g., “?” or “*”), where a placeholder qualifies all possible property values as a match for a property. For instance, the following provides an example sub-query template for a 1-hop graph traversal: _.outE(“includes”).has(“IsActive”,?).inV( ).has(“Status”,?). In this example sub-query template, an edge property “Status” is specified with the wildcard character “?”, and the leaf vertex property “Status” is specified with the wildcard character “?”. The wildcard characters allow for different values to be used to generate different 1-hop sub-query instances for a given root vertex. For instance, if the values for the “IsActive” template include true and false and the values for the “Status” template include 0 and 1, four different sub-query instances can be generated for the given root vertex using the different combinations of those values.

When a sub-query template includes a value instead of a placeholder, only sub-query instances with the matching value are cached. For instance, the use of a value in a sub-query template could be justified when a large percentage of sub-query instances use the value. As an example to illustrate, suppose “Status”=0 is used with high frequency while other “Status” values are rarely referenced. Caching the result of 1-hop sub-query instances with rare values provides little to no performance benefit. Additionally, they degrade the performance of graph updates by requiring them to either invalidate or refill potentially non-existent caches entries. A cache entry could be non-existent because the cache entry has either been evicted by the cache replacement policy due to a low recency of references or was invalidated by a previous write. This limitation can be addressed by having a sub-query template specify a frequently accessed value in its predicate (instead of a placeholder). This results in caching the result of 1-hop sub-query instances with the specified value for the property, while not caching results of 1-hop sub-query instances with different values. It also prevents updates from invalidating/refilling cache entries that do not use the frequently accessed value.

To illustrate, consider the following sub-query template: _.outE(‘Linking’).has(“IsActive”, *).inV( ).has(“Status”, 0). This sub-query template results in caching the results of 1-hop sub-query instances with “Status”=0 for leaf vertices. Thus, a 1-hop sub-query instance with “Status”=1 would not be cached. Moreover, a graph update involves invalidates/refills for only those cache entries corresponding to 1-hop sub-query instances with “Status”=0. In contrast, for a sub-query template with “Status”=′?′, every time the value of “IsActive” is updated with a root vertex Vᵢ that has a high fan-out, a large number of redundant invalidations/refills may have to be performed on a rarely referenced “Status” value. This is especially true when the different “Status” values have the same probability of occurrence. This is prevented by replacing the placeholder with the frequently referenced value.

A cache entry for a 1-hop sub-query instance is a key-value pair. The cache key for a cache entry identifies a unique 1-hop sub-query instance. The value for the cache entry is the output of the 1-hop sub-query instance, which can include any number of leaf vertex identifiers. The cache key includes at least the vertex identifier of the root vertex from the 1-hop sub-query instance. In some aspects employing sub-query templates, the cache key can also include a sub-query template identifier. Depending on the 1-hop sub-query instance, the cache key can further include other parameters, such as any combination of the following: (a) the direction (i.e., outgoing or incoming) of a referenced edge; (b) the label used to filter the edge; (c) the edge property names and/or values referenced by any predicates on the edge; (d) the label used to filter the leaf vertices; and (f) the property names and/or values referenced by a predicate applied to the leaf vertices. In some aspects, a list of all predicates referenced by a sub-query is maintained, and this list can be used to identify cache keys that should either be invalidated or refilled when performing graph updates.

In some embodiments, the cache data store 118 can include cache data beyond 1-hop sub-query instances. By way of example only and not limitation, the cache data could include cache entries that store vertex identifier results for multi-hop sub-query instances. As another example, the cache data could include cache entries that store properties of individual vertices.

Although depicted as two separate data store components, the graph data store 116 and the cache data store 118 can be embodied as a single data store. In some configurations, each the graph data store 116 and/or the cache data store 118 can reside on a single computer storage device or can be distributed across multiple storage devices. The storage devices can comprise, for instance, any combination of primary storage devices (e.g., memory such as RAM) and/or secondary storages devices (e.g., hard disk drives).

The query component 110 of the graph database system 104 processes graph queries to provide outputs based on the graph data. For instance, an application device, such as the application device 102, can submit a graph query to the graph database system 104, and based on that graph query, the query component 110 can query the graph data in the graph data store 116 and/or the cache data in the cache data store 118 to generate an output that is returned to the application device.

When processing a graph query, the query component 110 identifies one or more sub-queries and the sequence in which the sub-queries are to be processed. Each sub-query corresponds with a portion of the graph query and is processed in the sequence determined for the graph query. The results for each sub-query can be passed to the next sub-query in the sequence (if any), and the next sub-query is processed using those results. For instance, a first sub-query could specify a root vertex identifier and zero or more predicates on the labels and/or properties on edges and leaf vertices, and processing of that first sub-query could provide two leaf vertex identifiers as results. Those two leaf vertex identifiers are passed to the next stage for processing the second sub-query, which could include treating each of those vertex identifiers as a root vertex and identifying a set of leaf vertex identifiers for each based on zero or more predicates on the labels and/or properties on edges and leaf vertices in the second sub-query. Those two sets of leaf vertex identifiers can then be combined to provide a list of vertex identifiers that is passed to a next sub-query, if any. The query component 110 repeats this process until it exhausts all the sub-queries that constitute the graph query. The query component 110 processes the final set of vertices using the final clause of the graph query. At this point, the query component 110 has completed processing the graph query and produces the final result set as the query output.

For each 1-hop sub-query from a graph query, the query component 110 can identify one or more 1-hop sub-query instances that each corresponds with a root vertex identifier and other parameters, such as predicates on edges and/or leaf vertices specified by the sub-query. Continuing the example above, a single 1-hop sub-query instance could be identified for the first sub-query (based on the root vertex identifier specified by the first sub-query), and two 1-hop sub-query instances could be identified for the second sub-query (based on the leaf vertex identifiers returned by the first sub-query and passed to the second sub-query). In configurations using sub-query templates, the query component 110 can determine whether a sub-query matches a defined sub-query template in order to determine whether the sub-query can be processed using the cache data.

For a given 1-hop sub-query instance, the query component 110 generates a cache key based at least on a root vertex identifier. The cache key could also include other parameters, such as a sub-query template identifier, a direction of edges, edge label(s), leaf vertex label(s), property name(s) and/or value(s) of edge predicate(s), and/or property name(s) and/or value(s) of leaf vertex predicate(s). The query component 110 looks up the cache key in the cache data in the cache data store 118. If a cache entry with the cache key exists (i.e., a cache hit), a set of leaf vertex identifiers from the value in the cache entry is returned. For instance, the value can be deserialized and/or decompressed to obtain a list of leaf vertex identifiers. Each vertex identifier returned can then be treated as a root vertex of the next sub-query (if any). If a cache entry for the cache key does not exist (i.e., a cache miss), the query component 110 executes the 1-hop sub-query instance on the graph data in the graph data store 116, which returns a set of leaf vertex identifiers that can each be treated as root vertex of the next sub-query (if any).

In cases of a sub-query with multiple 1-hop query instances (e.g., a sub-query receiving multiple vertex identifiers from a previous sub-query), it's possible that some 1-hop query instances will result in cache hits and some 1-hop query instances will result in cache misses. In such cases, vertex identifiers returned from the cache data for cache hits can be combined with vertex identifiers returned from the graph data for cache misses to provide a list of vertex identifiers for that sub-query.

Some graph queries (1) retrieve a large amount of data, and/or (2) incur significant processing time. The former may perform one or more 1-hop sub-query traversals independent of retrieving a large amount of data. An example of the latter is merging two sets without sorting. In some aspects, the query component 110 uses query re-writing rules to optimize query processing. For instance, a first query re-writing rule could dictate: Do not retrieve user-defined properties with unique values associated with vertices when vertex identifiers can be used in their stead. As an example, suppose a graph query specifies: given a listing with user-defined listing identifier A, find all watch-lists that have it, and for each watch-list, retrieve all other listings that are different than A. In this case, using only vertex identifiers is sufficient to filter listings that are different than the original listing A, instead of using user-defined unique identifiers that requires one more round-trip to fetch their user-defined unique values.

A second query re-writing rule could dictate: Sort before merge. This applies to queries that compute the intersection of two sets consisting of m and n elements. Without sorting, the complexity of computing intersection is (m×n). With sorting, the complexity is reduced to (M×log M), where M=m(m, n). The application of these query re-writing rules to those queries that reference 1-hop sub-queries has no impact on the sub-queries. Thus, both the original and re-written queries can utilize identical sub-query templates and instances.

The cache component 112 of the graph database system 104 adds cache entries for 1-hop sub-query instances to the cache data in the cache data store 118. For a given 1-hop sub-query instance, the cache component 112 generates a cache key based on a root vertex identifier and can include other parameters, such as a sub-query template identifier, vertex/edge labels, and/or property values of vertices/edges. A value is generated by querying the graph data store 116 using the 1-hop sub-query instance to obtain a set of leaf vertex identifiers. In some cases, the leaf vertex identifiers are serialized and/or compressed to provide the value. The cache component 112 stores the key-value pair as a cache entry in the cache data store 118.

In some aspects, the addition of a cache entry for a 1-hop sub-query instance is performed as a single transaction. A transaction for a cache entry can include a series of operations, such as: generating a cache key (or receiving a previously generated cache key), performing a read on the graph data store 116 using the sub-query instance to retrieve a set of vertex identifiers, generate a value using the vertex identifiers, and performing a write on the cache data store 118 to add the cache entry as a key-value pair. All operations in a transaction are treated as a single unit such that either all changes are committed or none are. This ensures that the addition of the cache entry is executed in an atomic, consistent, isolated, and durable (ACID) manner, thereby guaranteeing the reliability and integrity of the transaction, even in cases of failure, such as power outages or system crashes.

The graph database system 104 can use a number of different approaches for determining when to add a cache entry for a 1-hop sub-query instance. In some aspects, the cache component 112 or another component identifies 1-hop sub-query instances by analyzing historical query data, for instance, to identify frequently processed 1-hop sub-query instances. In some aspects, the cache component 112 or another component analyzes the graph data to identify supernodes. For instance, a supernode could be identified based on a vertex having more edges than a threshold number.

In some aspects, the cache component 112 generates cache entries when execution of a graph query by the query component 110 experiences a cache miss for a 1-hop sub-query instance. This could be a single cache miss for the 1-hop sub-query instance or could require multiple cache misses for the 1-hop sub-query instance. For instance, a single cache miss involving a supernode could result in adding a cache entry, while multiple cache misses (e.g., a threshold number) could be required before a cache entry is added for a 1-hop sub-query instance that does not involve much data.

When adding a cache entry as a result of a cache miss, in some configurations, the addition can be synchronous with performing the graph query such that results from processing the 1-hop sub-query instance using the graph data are cached. However, this could negatively impact latency of the graph query, for instance, by turning a read transaction into a read/write transaction. Accordingly, in some aspects, addition of a cache entry from a cache miss is asynchronous by adding a cache populate job to a cache queue that is performed by the cache component 112 in the background. The cache populate job can include the 1-hop sub-query instance and, in some cases, the cache key that resulted in the cache miss. This asynchronous approach allows, for instance, the graph query to be performed as a read transaction separate from a write transaction to add the cache entry.

In some aspects, cache entries are generated using sub-query templates. As discussed above, a sub-query template identifies the structure for 1-hop sub-query instances that are cached. In some configurations, a sub-query instance must match a sub-query template in order for it to be cached. Otherwise, the sub-query instance is not cached and writes will not invalidate or refill its cache entry.

In some instances, a 1-hop sub-query instance could result in a large number of vertex identifiers, such as in the case of a supernode with a large number of connected vertices. If there is a limit on the size of a cache value, it may not be possible to use one cache entry for such a 1-hop sub-query instance. Accordingly, in some aspects, the cache component 112 can use multiple cache entries for the 1-hop sub-query instance. Different techniques could be employed to provide the multiple cache entries. For instance, in some configurations, a 2-level technique is used with one level-0 cache entry and multiple level-1 cache entries. The cache key of the level-0 cache is the cache key of the 1-hop sub-query instance. The value of the level-0 cache entry stores the cache keys of the level-1 cache entries, whereas the values of level-1 cache entries store the vertex identifiers. Retrieving a cache entry includes using the cache key for the 1-hop sub-query instance to identify the level-0 cache entry, using the cache keys in the value for that cache entry to access the values of the level-1 cache entries, and combining the resulting vertex identifiers. In other configurations, the cache value is split into chunks, and each chunk is stored as a cache value where its cache key is the original key appended with a chunk index. Retrieving a cached entry in this case becomes a range query on its cache key as the prefix to retrieve all the chunks and combining the resulting vertex identifiers.

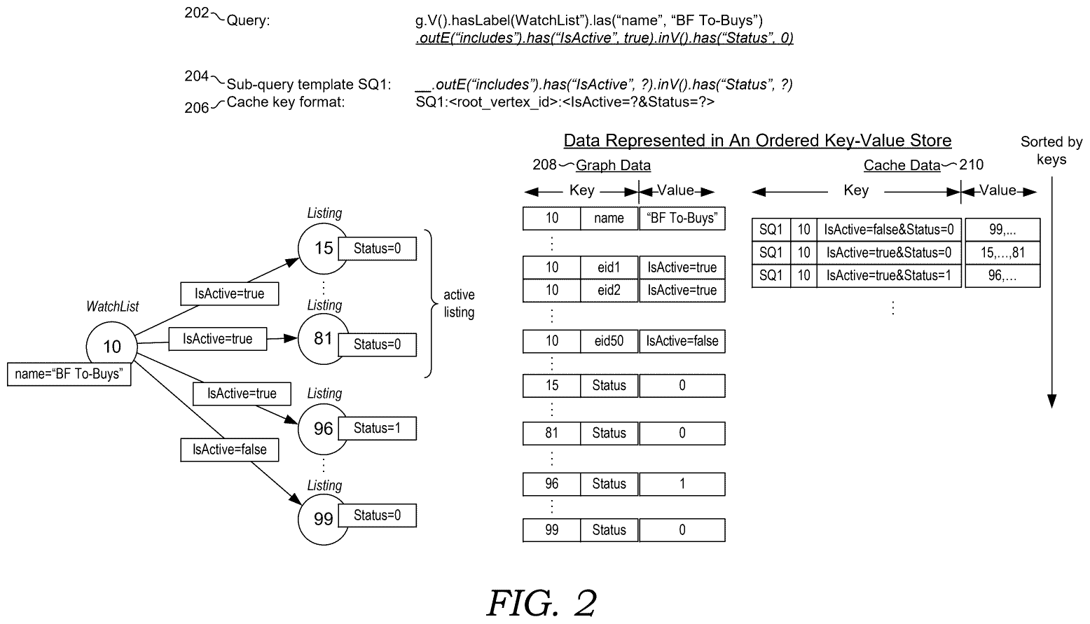

FIG. 2 provides an example to illustrate aspects of the present technology. In the present example, a watch-list of a user on an e-commerce site may have multiple listings where each listing may be either active or inactive. The graph data models watch-lists and listings as vertices. If a listing is included in a watch-list, there is an edge labeled “includes” from the watch-list to the listing. Each listing has a property named “Status” with a binary value, either 1 or 0, denoting the listing's availability. Moreover, to track a user's behavior, if a listing is removed from a watch-list, the edge from the watch-list to the listing is maintained and the “IsActive” property value for the edge is set to false.

In the present example, suppose a watch-list “BF To-Buys” includes 50 listings where 30 edges are active (“IsActive”=true). A user may be interested in only available listings, i.e., Status=0. The graph query 202 g.V( ).hasLabel(“WatchList”).has(“name”, “BF To-Buys”).outE(“includes”).has(“IsActive”, true).inV( ).has(“Status”, 0) can be used to identify these listings.

Using only graph data 208 (i.e., without caching) to return an output, the graph query 202 can be processed as follows. First, the process retrieves the identifier of the watch-list vertex using an index. Subsequently, the process issues a getRange to retrieve all those edges that satisfy the predicate “isActive=true”, identifying the 30 qualifying edges that each, in turn, identify a listing (encoded as a part of the edge identifiers). For each of those listings, the process issues a getRange request to retrieve its “Status” property and filters those that satisfy the predicate “Status=0”. Only a subset of these 30 listings satisfies this predicate, and the vertex identifiers for those listings are returned. Thus, processing of this graph query 202 using only the graph data 208 requires two network round-trips plus local processing to filter the qualifying vertices. Similar graph queries that fetch more data for either the edge predicate or the leaf vertex predicate may require more network round-trips when a batch size for a multi-retrieval optimization is applied.

In contrast to the above operations to process the graph query 202 using only the graph data 208 without caching, the following provides a description of operations using the cache data 210 in accordance with aspects of the present technology. In this example, the relevant sub-query template 204 for the graph query 202 is .outE(“includes”).has(“IsActive”,?).inV( ).has(“Status”,?), and the cache key format 206 for this sub-query template 204 is SQ1:<root_vertex_id>:<IsActive=?&Status=?>.

Using this sub-query template 204, the cache data 210 has been provided by generating cache keys with the vertex identifier “10” as the root vertex and using different combinations of the property values of the edge property “IsActive” (i.e., true and false) and the property values of the leaf vertex property “Status” (i.e., 0 or 1). For instance, the following cache keys have been generated: SQ1:10:IsActive=false&Status=0; SQ1:10:IsActive=true&Status=0; and SQ1:10:IsActive=true&Status=1, where each cache key includes “SQ1” to reference the sub-query template 204, “10” to reference the vertex identifier of the watch-list (which has the “name” equal to “BF To-Buys”), followed by an edge property value for the “IsActive” property and a vertex property value for the “Status” property. For each cache key, the graph data 208 was used to identify resulting leaf vertices, and a cache entry was added to the cache data 210 as a key-value pair that comprises the cache key and the resulting leaf vertices as the value. In some aspects, the cache value for each cache entry can comprise the identified listing identifiers serialized into bytes.

When the graph query 202 is received, the graph query 202 can be identified as having a 1-hop sub-query that matches the sub-query template 204. A cache key is generated for the 1-hop sub-query as follows: SQ1:10:IsActive=true&Status=0, where “SQ1” references the sub-query template 204, “10” is the vertex identifier of the watch-list (which has the “name” equal to “BF To-Buys”), and “IsActive=true&Status=0” provide the property values of the edge property “IsActive” and the leaf vertex property “Status”. The cache key is used to perform a lookup in the cache data 210. Observing a cache hit, the vertex identifiers provided by the value associated with the cache key are used to generate an output that comprises the listings for those vertex identifiers, which is returned as a response to the graph query 202.

In comparison to the approach using only graph data 208, each time the graph query 202 is received and observes a cache hit: the two network round-trips are reduced to one for a cache lookup, the amount of data retrieved is reduced, and the cost of deserializing a value and processing for evaluating the query predicate is eliminated. As such, the approach using caching can provide significant performance improvement over the approach without caching.

A well-chosen sub-query template can also be used in multiple sub-queries. For example, suppose another graph query is processed to retrieve all other listings that are included in at least one common watch-list with a particular listing having the listing identifier “ABC”. For instance, the Gremlin expression for this graph query could be g.V( ).hasLabel (“Listing”).has(“id”, “ABC”).inE(“includes”).has(“IsActive”, true).outV( ).hasLabel (“WatchList”).outE (“includes”).has(“IsActive”, true).inV( ).has(“Status”,0).valueMap( ). This example graph query includes multiple sub-queries. The second-hop sub-query of the graph query matches the defined sub-query template 204 and may be used to access multiple cache entries, where each cache key is associated with each watch-list found at the first-hop traversal.

With reference again to FIG. 1, the update component 114 of the graph database system 104 updates the cache data (i.e., cache write operations) based on updates to the graph data (i.e., graph write operations). An update to the cache data can either invalidate or refill impacted cache entries. While invalidate deletes the impacted cache entries, refill updates impacted cache entries (e.g., by adding or removing vertex identifiers).

In some configurations, the update component 114 performs writes that modify both the graph data and impacted cache entries of the cache data in a transactional manner. In particular, modifications to both the graph data and the cache data are performed as a write transaction. A write transaction for a graph update includes multiple operations including: identifying impacted cache entries for the graph update, performing graph write operation(s) to modify the graph data, and performing cache write operation(s) to modify impacted cache entries. As indicated above, the cache write operations can either invalidate or refill the impacted cache entries. Modifying both the graph data and the cache data in a single write transaction preserves the consistency of the cache entries with the graph state.

In some aspects, the type of graph update impacts how the update component 114 identifies impacted cache entries and how the update component 114 modifies those impacted cache entries. When a graph update is provided, the update component 114 determines the type of graph update. The update component 114 then determines one or more impacted cache entries by generating impacted cache keys based on the graph update and its type. The update component 114 also determines how to modify the impacted cache entries (i.e., either invalidate or refill), which can also be based on the type of graph update. The update component 114 then uses the impacted cache keys to modify the impacted cache entries (i.e., either invalidate or refill). As noted above, in some aspects, the operation(s) to identify impacted cache entries for a graph update and the write operation(s) to modify the cache data are performed as a single write transaction that also include write operation(s) to modify the graph data.

An update to the graph data can include one or more of following graph update types:
(1) add a new edge between two vertices, Vᵢ and Vⱼ;
(2) delete an edge between two vertices, Vᵢ and Vⱼ;
(3) add a property value to an edge between two vertices, Vᵢ and Vⱼ;
(4) delete a property from an edge between two vertices, Vᵢ and Vⱼ;
(5) update a property value of an edge between two vertices, Vᵢ and Vⱼ;
(6) add a new property with a value to vertex Vᵢ;
(7) delete a property and its value from vertex Vᵢ;
(8) update a property value of vertex Vᵢ;
(9) delete a vertex Vᵢ;
(10) add a vertex Vᵢ.

While most of these graph updates may impact a cache entry, adding a vertex by itself is a graph update that does not impact the result of a sub-query instance, i.e., a cache entry. Hence, it is not considered. With the first five graph updates above, the direction of the edge can be used for identifying the impacted cache entries.

Refill has two possible definitions when a graph update results in a new cache entry that did not exist previously. An example is a graph update that adds a new property value to Vᵢ, causing some sub-queries to produce a vertex list for Vᵢ that did not exist previously. One definition of refill is to do nothing. This will require a future query that references the sub-query with Vᵢ to observe a cache miss and populate the cache. Another definition is to require the write operation to populate the cache data with the missing new cache entry, enabling any future query to observe a hit. The former is advantageous when a future query never references the new cache entry. The latter is advantageous when many future queries reference the new cache entry almost immediately and frequently. Its disadvantage is that it slows down the write transaction by requiring it to populate the cache data synchronously. This section assumes the second definition of refill.

In order for the update component 114 to identify impacted cache entries for graph updates, it may require the vertex property names and values used by the different sub-queries. The property names may be obtained once at system initialization time by processing the sub-query templates. The value of these properties for the impacted vertices may be obtained once before the update component 114 identifies the impacted sub-queries. The following describes the different types of graph updates, how impacted cache entries are identified for each, and how to modify the impacted cache entries. In some aspects, each graph update described below can comprise a series of operations that are performed as a single write transaction.

Add a new edge between two vertices, Vᵢ and Vⱼ: The direction of the edge may be used. It is assumed the edge is outgoing from Vᵢ and Vⱼ. The inverse of this is a simple switch of subscript for the following discussion.

The update component 114 computes the impacted cache entries by analyzing the individual sub-query templates. A sub-query template may traverse an incoming edge, an outgoing edge, or both. These are discussed in turn. With the first two, it evaluates whether Vᵢ as the root of the sub-query template satisfies Vⱼ as a leaf vertex using the properties of the new edge, Vᵢ and Vⱼ. If affirmative, then the result of the sub-query instance using Vᵢ as its root has changed. The update component 114 constructs the impacted key for the sub-query template using Vᵢ's vertex identifier. Next, the update component 114 either deletes the corresponding cache entry (invalidate) or refills the cache entry by adding Vⱼ to its result set. With the second scenario, the update component 114 examines the sub-query instance using either Vᵢ or Vⱼ as the root, repeating the above with each as the root vertex.

A sub-query template may reference one or more properties of a leaf vertex (e.g., the “Status” property in the example of FIG. 2). The value of this property for the leaf vertex is used to construct the cache key of an impacted cache entry. The new edge, Vᵢ and Vⱼ, has the properties referenced by the query template. Otherwise, the update component 114 computes no cached key.

To illustrate, consider the sub-query template 204 of FIG. 2 and assume the edge being added has an “IsActive” property and its value is true. Since the sub-query traverses the outgoing edges of a root vertex, the update component 114 will consider only Vᵢ as the root. For vertex Vᵢ=10, suppose the graph update is an outgoing edge from that root vertex to a new listing vertex, Vⱼ=101, with Status=0. The update component 114 instantiates the sub-query template 204 using the property value of this edge (“IsActive=true”) and the property value of the new listing vertex (“Status=0”) to construct the impacted cache key SQ1:10:IsActive=true&Status=0. Subsequently, the update component 114 either deletes this cache key or refreshes it to include Vⱼ=101.

Consider a similar scenario with a different sub-query template, SQ6:_.bothE(‘includes’).has(“IsActive”, *).inV( ).has(“Status”, *). With Vᵢ=10 as the root vertex, the update component 114 key computes the impacted cache SQ6:10:IsActive=true&Status=0. Invalidate deletes the cache entry for this cache key, while refill updates the cache entry with Vⱼ=101. The update component 114 repeats this process with Vᵢ=101 as the root vertex. If it detects the child vertex, Vᵢ=10, is missing the “Status” property, the process terminates. However, if Vᵢ=10 has the “Status=1” property, then the update component 114 proceeds to construct the impacted key SQ6:101:IsActive=true&Status=1 and either deletes the cache entry for this cache key or refills the cache entry with Vi=10.

Delete an existing edge: The process of identifying the impacted cache entries and invalidating them is identical to adding a new edge with one difference. With refill, a leaf vertex, either Vᵢ or Vⱼ, may be deleted from the cached result of a sub-query instance.

Add a property value to an edge: This is handled in the same manner as adding a new edge.

Delete a property value of an edge: This is handled in the same manner as removing an edge.

Update a property value of an edge: This is identical to removing an edge with the old property value and adding a new edge with the new property value. Accordingly, the respective operations for adding an edge and deleting an edge above are applicable. The process eliminates duplicate cache keys prior to either invalidating or refilling them.

Add a new property with a value to vertex Vᵢ: The update component 114 identifies all sub-query templates that reference the new property. A sub-query may apply the predicate to either a root vertex or a leaf vertex. The following discusses each in turn. With the former, the operations include generating a cache key that did not exist previously. Hence, there is no cache entry to delete with invalidate. With the above definition of refill, the update component 114 uses Vᵢ as the root of the sub-query and computes its leaf vertices, generating a new cache entry that it inserts in the cache data store 118.

With a sub-query that references the new property to qualify a leaf vertex, the update component 114 identifies those vertices { } that are one hop away from Vᵢ. The update component 114 uses each vertex Vⱼ in { } as the root of the sub-query and evaluates whether Vᵢ qualifies by instantiating the sub-query. If affirmative, with invalidate, the cache entry corresponding to the result of the sub-query instance with Vⱼ as its root vertex is deleted. With refill, Vᵢ is added to the cache entry for the sub-query instance and Vⱼ as its root vertex.

Delete a property and its value from vertex Vᵢ: Similar to adding a new property, the update component 114 identifies all sub-query templates with a predicate that references the deleted property. The update component 114 also identifies whether the sub-query applies the predicate to a root vertex, a leaf vertex, or both. With the root vertex, the update component 114 uses Vᵢ and its old property value to construct the cache key of the impacted cache entry for the query template. The update component 114 deletes the cache entry for this cache key with both invalidate and refill.

When a sub-query template uses the old property to qualify leaf vertices, an instance of it may no longer have Vi in its result set. Hence, the update component 114 identifies all such sub-query templates. Next, the update component 114 identifies those vertices { } that are one hop away from Vᵢ. With each sub-query template, the update component 114 uses a vertex Vⱼ in { } as the root of the sub-query and evaluates whether Vᵢ qualifies with its deleted property and old value. If affirmative, the update component 114 constructs the cache key of each sub-query instance with Vⱼ as its root vertex. The update component 114 deletes the cache entries for these cache keys with invalidate. With refill, the update component 114 updates each impacted cache entry by removing Vᵢ from the value of the cache entry for each cache key.

Update a property value of a vertex Vᵢ: This is equivalent to first deleting the property with its old value and subsequently adding the property with its new value. Accordingly, the previous discussion of those two types of graph updates are applicable.

Delete a vertex Vᵢ: The update component 114 examines all sub-queries. For each, the update component evaluates whether Vᵢ satisfies the predicate applied to the root or a leaf vertex. With the root vertex and an instantiated sub-query template using Vᵢ's properties and edges, the update component 114 constructs the cache key identifying the cache entry. The update component deletes this cache entry with both invalidate and refill. With immutable vertex identifiers, the failure to perform this delete does not impact correctness because a deleted vertex is not reachable to be used by a sub-query.

With the leaf vertex, the update component 114 identifies the set of vertices { } that are one hop away from Vᵢ. For each vertex Vᵢ in { }, the update component 114 instantiates a query template using Vⱼ's properties and edges to determine if Vᵢ is reachable, i.e., qualifies. If this is the case, then the update component 114 constructs the impacted cache key using the instantiated query template with Vⱼ as its root vertex. The update component 114 deletes the cache entry for this cache key with invalidate. With refill, the update component 114 removes Vᵢ from the value of the cache entry for that cache key.

In some configurations, the update component 114 uses batch processing that involves multiple edges and/or vertices being updated. Instead of identifying the impacted cache keys individually for each graph update, the update component 114 can process all graph updates prior to a transaction commit. The batch processing can include leverage these benefits: from changed edges, querying properties of both ends in bulk; and from changed vertices, querying their root vertices in bulk.

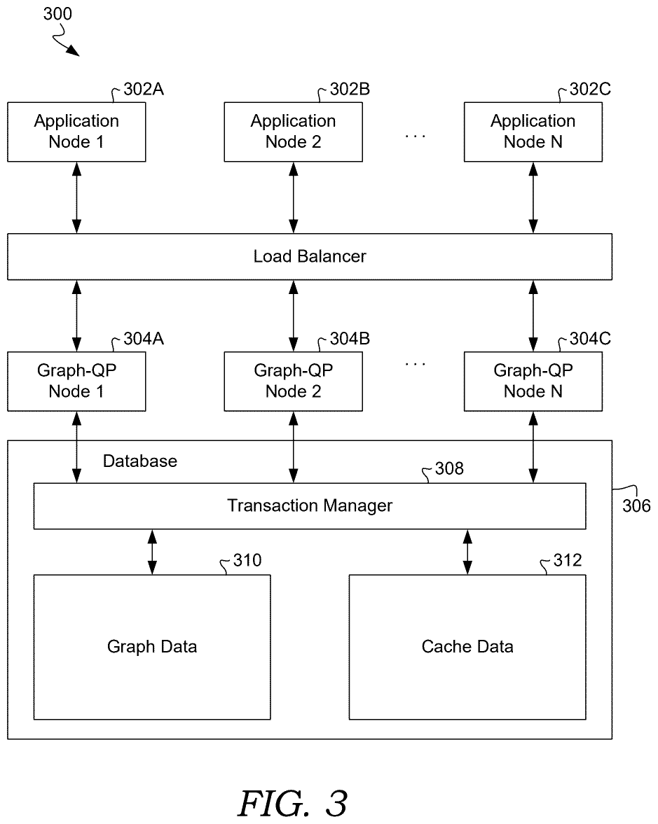

With reference now to FIG. 3, a block diagram is provided showing an example implementation of a framework 300 using 1-hop sub-query caching. This framework 300 is provided by way of example only and not limitation. Other implementations using 1-hop sub-query caching can be provided using the technology described herein.

The framework 300 comprises a distributed system having a number of graph query processors (including graph query processors 304A, 304B, 304C), a database 306 having a transaction manager 308, and a service coordinator (not shown). The database 306 can comprise a transactional storage manager (such as FoundationDB) that comprises stateful components that implement both graph data 310 and cache data 312. In the current implementation, there is not an extra deployment for cache data. Instead, cache entries are stored (e.g., in an FoundationDB subspace) separate from the main subspace that stores graph data (e.g., in another Foundation subspace). The transaction manager 308 manages reads and writes to both the graph data 310 and the cache data 312. Accordingly, operations on the cache data 312 (e.g., get/set/clear/clearRange) are part of the transactions that process read/write graph traversals. The benefit of this setup includes the following: (1) no need for an extra-deployment for cache, thus reducing the overhead of operating and monitoring; (2) do not need a lease mechanism to maintain the cache data 312 consistent with the graph data 310, since both database and cache requests can be combined in one transaction; and (3) good characteristics of cache are inherited from using a transaction store manager, such as, supporting multi data centers without any effort, persistence, and cache keys are sorted.

The graph query processors are stateless virtual servers that are created on demand. The graph query processors process graph queries from application nodes (such as application nodes 302A, 302B, 302C), look up the cache for processing read queries, and implement cache invalidation with writes. A newly launched graph query processor registers itself with the service coordinator. The service coordinator facilitates graph query processor discovery and removes bad graph query processors from a deployment. The service coordinator also implements the life-cycle of a sub-query template from the time it is registered to the time it is disabled and removed from the system, as described in further detail below.

In the present example, a cache entry is a key-value pair stored in the cache data 312. The value of a cache key is the result of its corresponding sub-query instance, i.e., a list of leaf vertex ids. The cache key is based on a root vertex identifier and can also include a prefix, parameter values of predicates presented in its sub-query instance, and other parameters as appropriate. The prefix is unique for each sub-query template and may be a generic byte array. In some aspects, unique strings are used for the prefix to make cache keys and monitoring logs easier to process for debugging and troubleshooting purposes. All cache keys belonging to a sub-query template can have the same unique prefix. These cache keys for the same sub-query template can be stored together, such that deleting cache entries with cache keys belonging to a sub-query template can be performed quickly and efficiently.

Cache values can be compressed to reduce cache storage and network transmission overhead. For instance, the Zstandard data compression algorithm could be used for compression, which in micro-benchmarks has shown advantages in both compression/decompression time and compression ratio compared with others. Even with compression, it is possible that a cached value may become larger than an allowed max value size (e.g., 100 k bytes). To handle this case, in some configurations, the cache value is split into equal chunks, and each chunk is stored as a cache value where its cache key is the original key appended with a chunk index. Invalidating a cached entry is a clear range with the cache key as the prefix of the range. Retrieving a cached entry becomes a range query on its cache key as the prefix to retrieve all the chunks. Chunks are combined to construct the original compressed value. Next, this value is decompressed and deserialized to obtain the cached sub-query result.

The implementation of FIG. 3 populates the cache data 312 asynchronously once a sub-query instance observes a cache miss. In contrast to synchronous caching, this expedites the processing of a graph query by preventing it from incurring the overhead of populating the cache data 312. Moreover, it prevents a read query from becoming a read-write transaction. Once the query processor observes a cache miss for a sub-query instance and a root vertex identifier, the query processor inserts the sub-query instance and the root vertex identifier in a queue processed by background threads. Next, the query processor processes the sub-query instance using the root vertex identifier.

One or more background cache populate threads process the queue of sub-query instances and their root vertex identifiers. These threads are hosted on the graph processors in the implementation of FIG. 3. A cache populate thread executes a transaction that includes the processing of the sub-query instance using its provided root vertex identifier, constructing the unique key for this sub-query instance and its vertex identifier, obtaining the resulting leaf vertex identifiers and serializing them as the value of the cache key, and inserting this key-value pair in the cache data 312. This transaction may fail to commit. The cache populate thread executes the entire transaction a pre-specified number of times prior to discarding it.

In some aspects, a sub-query that observes a cache miss is processed twice. A first time is by the graph query processor and a second time by a cache populate thread using the same graph query processor. This prevents a read query from becoming a read-write transaction. To elaborate, storage managers differentiate between their read and write paths, optimizing each path independent of the other. For example, FoundationDB implements an efficient read path by allowing a client to fetch its data directly from a storage manager process. Its writes path implements the optimistic concurrency control protocol with multi-version concurrency control. In essence, a complex query that reads a lot of data does not incur the overhead of a concurrency control protocol and transaction commit. Accordingly, in some aspects, graph queries that observe a cache miss use the read path, while cache populates that populate the cache data 312 with the missing cache entries use the write path.

To handle graph updates, the write path is modified to identify impacted cache keys. For instance, Gremlin provides a mutation listener interface that raises events when a graph update occurs. For each graph update, the old and new state are captured, and a check is performed to determine whether either state impacts a sub-query template. To illustrate, consider a sub-query template Q with “Status=?”. A graph update that changes the “Status” property value of a vertex from 0 to 1 invokes a listener that provides both the old and new value of the “Status” property. This information is used to construct the cache keys of impacted cache entries in order to modify those impacted cache entries (e.g., via invalidate or refill). With FoudationDB, invalidation of cache keys and other graph updates are buffered in a write transaction and are submitted at its commit time. With this implementation, a write can either delete a fixed number of cache keys or clear a fixed number of ranges.

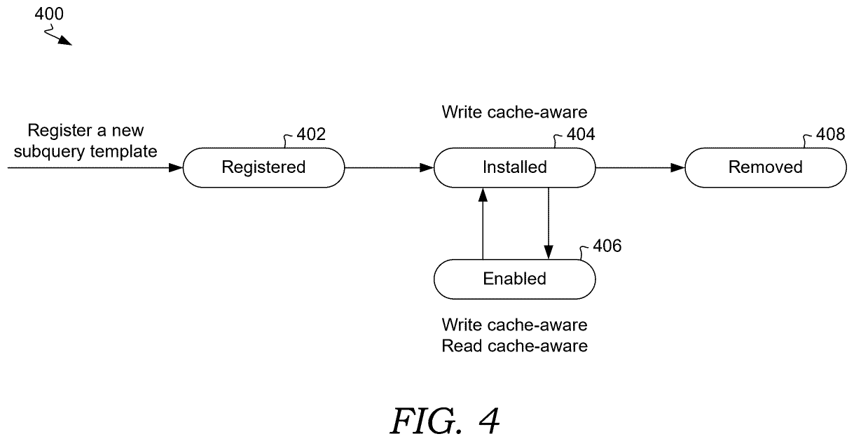

A sub-query template can be added or removed (e.g., automatically or manually by a system administrator) in an online manner without compromising consistency or restarting the system. This is not trivial since messaging delays and different form of failures prevent enabling or disabling a sub-query template on all graph processors instantaneously. FIG. 4 provides a block diagram showing the life-cycle of a sub-query template in accordance with some aspects. A sub-query template may have four possible states: registered 402, installed 404, enabled 406, or removed 408. When a new sub-query template is added, its initial state is registered 402.

A service coordinator can initiate a two-phase workflow to enable the sub-query template. In phase one, the service coordinator notifies all graph processors to register the new sub-query template. Once all graph processors in the deployment confirm, the service coordinator changes the state of this sub-query template to installed 404. Each graph processor upon receiving the register message starts to invalidate cache entries with writes that impact the result of sub-query instances of the sub-query template. These writes may invalidate non-existent cache entries as reads have not yet been enabled and are not populating the cache. In phase two, the service coordinator sends a message to all graph processors to activate reads on cache entries, which results in caching the result of sub-query instances corresponding to the sub-query template when cache miss happens. Once all graph processors acknowledge, the service coordinator changes the state of the sub-query template to enabled 406.

The caching of a sub-query template can be disabled. This may be, for instance, due to a change in the traffic pattern where reads reference the sub-query template either rarely or never. The administrator does not want the system to incur the overhead of writes invalidating cache entries corresponding to the sub-query template. In this case, the service coordinator initiates the reverse process to remove an enabled sub-query template and to reclaim the space occupied by its cache entries. This can include a two-phase workflow. In phase one, the service coordinator requests each graph processor to stop using the sub-query template with reads. The graph processors continue to require writes to invalidate cache entries corresponding to the instances of this sub-query template. Once all graph processors confirm that they have stopped reads from using the cache with this sub-query template, the service coordinator changes the state of the template to installed 404. Next, phase two is triggered by requesting each graph processor to stop requiring writes to invalidate cache entries corresponding to the sub-query instances of the disabled sub-query template. Once all graph processors confirm, the service coordinator deletes the cached keys by issuing a clearRange( ) operation on the sub-query template cache-key prefix, (e.g., “SQ1” in FIG. 2). This frees up the space occupied by the cache entries. Next, the service coordinator marks the sub-query template as removed 408. The service coordinator continues to track deactivated sub-query templates for auditing and troubleshooting purposes.

At each phase, the service coordinator waits for all graphic processors to confirm. If a request to a graph processor fails or times out, the service coordinator resends the request until it receives a successful reply.

In some configurations, there are multiple service coordinator replicas where only one primary service coordinator replica is granted with a lease to implement the workflow and modify the state of different sub-query templates. The secondary service coordinators maintain a copy of the current state of the sub-query templates in their metadata database. If the primary service coordinator fails or becomes network unreachable, a secondary replica is assigned the new lease once the lease granted to the primary expires. This replica becomes the primary and resumes processing of the workflow by resetting the unfinished phase and resuming the workflow from it.

The following provides pseudo-code for nine algorithms used in some aspects. For instance, in some implementations, these algorithms can be incorporated into Graph-QP with FoundationDB (FDB) as the storage manager. These algorithms are categorized into two groups, utility algorithms and those that implement changes as described herein. The latter depends on the former. The utility algorithms are: Evaluate, DeleteKeysForRoot, DeleteKeysForLeaf, HandleEdgeChange, and ExtractWildcardValues. The algorithms that use the utility algorithms to implement changes and maintain the cache consistent with the graph database include: Delete Vertex, Change Vertex Property, Add/Delete Edge, and Change Edge Property. In some aspects, these algorithms can be triggered by a Gremlin-provided mutation listener interface. Hence, these algorithms detect and delete the cache entries. The mutation of the graph database in such implementations can be performed by the Graph-QP.

For the change implementing algorithms, algorithm 1 (Delete Vertex) is directed to implementing a graph change in response to deleting a vertex:

Algorithm 1 Delete Vertex (Vᵢ)

| | Description: Triggered when vertex Vᵢ is deleted. |
|---|---|
| 1: | for each SQₜ with P^{r}, P^{e} and P^{l} do |
| 2: | if Evaluate(P^{r}, Vⁱ) = = true then |
| 3: | DeleteKeysForRoot(SQₜ, Vᵢ) |
| 4: | end if |
| 5: | DeleteKeysForLeaf(Vᵢ, SQₜ) |
| 6: | end for |

Algorithm 2 (Change Vertex Property) handles deletion and addition of a vertex property as a special case. Algorithm 4 (Change Edge Property) similarly handles the deletion and addition of an edge property. Both assume if the input value of newval is null, then the property is being deleted. If P is missing from Vᵢ/E and newval has a valid value, then the property is being added. Algorithm 3 (Add/Delete Edge) handles the addition and deletion of an edge.

Algorithm 2 Change Vertex Property (Vᵢ, P, newVal)

| | Description: Triggered when the property P of Vᵢ is changed. |
|---|---|
| | If newVal is null, P is deleted from Vᵢ. If newVal is not null, Vᵢ |
| | has P set to newVal. |
| 1: | V_{old} ← Vᵢ |
| 2: | V_{new} ← Vᵢ with P = newVal |
| 3: | for each SQₜ with P^{r}, P^{e}, and P^{l} do |
| 4: | if P appears in P^{r} then |
| 5: | if Evaluate(P^{r}, V_{old}) or Evaluate(P^{r}, V_{new}) then |
| 6: | DeleteKeysForRoot(SQₜ, Vᵢ) |
| 7: | end if |
| 8: | end if |
| 9: | if P appears in P^{l} then |
| 10: | DeleteKeysForLeaf(V_{old}, SQₜ) |
| 11: | DeleteKeysForLeaf(V_{new}, SQₜ) |
| 12: | end if |
| 13: | end for |

Algorithm 3 Add/Delete Edge (E, Vᵢ, Vⱼ)

| | Description: Triggered when an edge E from Vᵢ to Vⱼ is |
|---|---|
| | added/deleted. |
| 1: | for each SQₜ with P^{r}, P^{e}, and P^{l} do |
| 2: | HandleEdgeChange(Sqₜ, E, Vᵢ, Vⱼ) |
| 3: | end for |

Algorithm 4 Change Edge Property (E, Vᵢ, Vⱼ, p, newVal)

| | Description: Triggered when the property P of edge E from |
|---|---|
| | Vᵢ to Vⱼ changes its value. If newVal is null, P is deleted from |
| | E. if newVal is not null, E has P set to newVal. |
| 1: | E_{old} ← E |
| 2: | E_{new} ← E with P = newVal |
| 3: | for each SDₜ with P^{r}, P^{e} and P^{l} do |
| 4: | if P appears in P^{e} then |
| 5: | HandleEdgeChange(SQₜ, E_{old}, Vᵢ, Vⱼ) |
| 6: | HandleEdgeChange(SQₜ, E_{new}, Vᵢ, Vⱼ) |
| 7: | end if |
| 8: | end for |

For the utility algorithms, algorithm 5 (Evaluate) is used to evaluate a graph element (i.e., either a vertex or an edge) with a given predicate Pred. Algorithm 7 (DeleteKeysForLeaf) and algorithm 8 (HandleEdgeChange) delete keys from the cache one at a time. Each algorithm assumes FDB's fat client that buffers these deletes and submits them to its server for processing at transaction commit time. If a thin client is assumed that does not buffer writes, then these utility algorithms can be adjusted to identify all keys to be deleted and submit one delete request for all keys to the server component of the storage manager. Algorithm 6 (DeleteKeysForRoot) demonstrates another feature of FDB, its ability to clear a range of values starting with a prefix. It simply computes the first portion of a key with the identifier of the query template along with the vertex ID as the prefix. FDB deletes all keys starting with this prefix. Algorithm 9 (ExtractWildcardValues) is used to extract values of wildcard properties of a predicate.

Algorithm 5 Evaluate (Pred, X)

| | Description: Evaluate the graph element X, either a vertex or |
|---|---|
| | an edge, with the given predicate Pred. |
| 1: | labelPred ← Extract label predicate from Pred |
| 2: | propPreds ← Extract property predicates (without wildcards) |
| | from pred |
| 3: | if label_predicate applied to X.label == false then |
| 4: | return false |
| 5: | end if |
| 6: | for each propP in propPreds do |
| 7: | if X.p is missing or propP applied to X.P == false then |
| 8: | return false |
| 9: | end if |
| 10: | end for |
| 11: | return true |

Algorithm 6 DeleteKeysForRoot (SQₜ, V)

| | Description: Delete all cache keys where root vertex is V. |
|---|---|
| 1: | prefix ← Concat SQₜ.name with V.id |
| 2: | Clear range starting with : prefix from cache |

Algorithm 7 DeleteKeysForLeaf (L, SQₜ)

| | |
|---|---|
| 1: | P^{r}, P^{e}, P^{l} ← root, edge, and leaf predicates of SQₜ |
| 2: | if L does not have all wildcard properties in P^{l} then |
| 3: | return |
| 4: | end if |
| 5: | if Evaluate(P^{l}, L) == false then: |
| 6: | return |
| 7: | end if |
| 8: | W^{l} ← ExtractWildcardValues(P^{l}, L) |
| | // Identify the direction to query for potential edges and roots |
| 9: | tDir ← Edge direction specified in SQₜ |
| 10: | reverseDir ← Init direction of the reverse query |
| 11: | if tDir == outgoing then |
| 12: | reverseDir ← incoming |
| 13: | else if tDir == incoming then |
| 14: | reverseDir ← outgoing |
| 15: | else if tDir == both then |
| 16: | reverseDir ← both |
| 17: | end if |
| 18: | Es ← Edges with direction reverseDir from V that satisfies P^{e} |
| 19: | for each edge E in Es do |
| 20: | if E does not have all wildcard properties in P^{e} then |
| 21: | continue |
| 22: | end if |
| 23: | W^{e} ← ExtractWildcardValues(P^{e}, E) |
| 24: | R ← Vertex different than L (at the other side) from E |
| 25: | if Evaluate(P^{r}, R) = = True then |
| 26: | k ← Concat SQₜ.name, R.id, W^{e}, W^{l} |
| 27: | Delete k from the cache |
| 28: | end if |
| 29: | end for |

Algorithm 8 HandleEdgeChange (Sqₜ, E, Vᵢ, Vⱼ)

| | |
|---|---|
| 1: | P^{r}, P^{e}, P^{l} ← root, edge, and leaf predicates of SQₜ |
| 2: | if E does not have all wildcard properties in P^{e} then |
| 3: | return |
| 4: | end if |
| 5: | if Evaluate(P^{e}, E) == false then: |
| 6: | return |
| 7: | end if |
| 8: | W^{e} ← ExtractWildcardValues(P^{e}, E) |
| | //Compute possible {root, leaf} pairs (at most 2) |
| 9: | rootLeafCandidates ← Init array [ ] |
| 10: | direction ← Edge direction specified in SQₜ |
| 11: | if direction == outgoing or both then |
| 12: | Append {Vᵢ, Vⱼ} to rootLeafCandidates |
| 13: | end if |
| 14: | if direction == incoming or both then |
| 15: | Append {Vⱼ, Vᵢ} to rootLeafCandidates |
| 16: | end if |
| 17: | for each R, L in rootLeafCandidates do |
| 18: | if L does not have all wildcard properties in P^{l} then |
| 19: | continue |
| 20: | end if |
| 21: | matchRoot ← Evaluate(P^{r}, R) |
| 22: | matchLeaf ← Evaluate(P^{l}, L) |
| 23: | if matchRoot == true and matchLeaf == true then |
| 24: | W^{l} ← ExtractWildcardValues(P^{l},L) |
| 25: | k ← Concat SQₜ.name, R.id, W^{e}, W^{l} |
| 26: | Delete k from the cache |
| 27: | end if |
| 28: | end for |

Algorithm 9 ExtractWildcardValues (Pred, X)

| | Description: Extract values of wildcard properties of the predicate |
|---|---|
| | Pred from graph element X, either a vertex or an edge. |
| 1: | wilcardVals← Init map { } |
| 2: | for each wildcard property P on Pred do |
| 3: | Add (P.name, X.P) to wildcardVals |
| 4: | end for |
| 5: | return wildcardVals |

Example Methods for Graph Databases with 1-Hop Sub-Query Caching

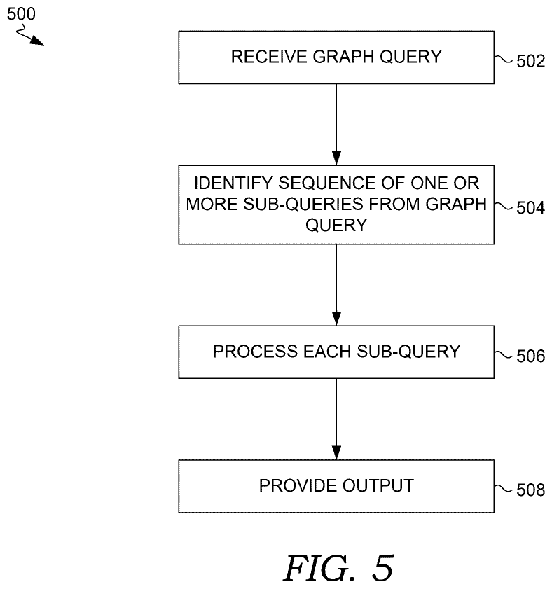

With reference now to FIG. 5, a flow diagram is provided that illustrates a method 500 for processing a graph query. The method 500 can be performed, for instance, by the graph database system 104 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, a graph query is received. For instance, the graph query could be received from an application device, such as the application device 102 of FIG. 1. The graph query is analyzed at block 504 to identify a sequence of one or more sub-queries with at least one sub-query corresponding to a 1-hop graph traversal.

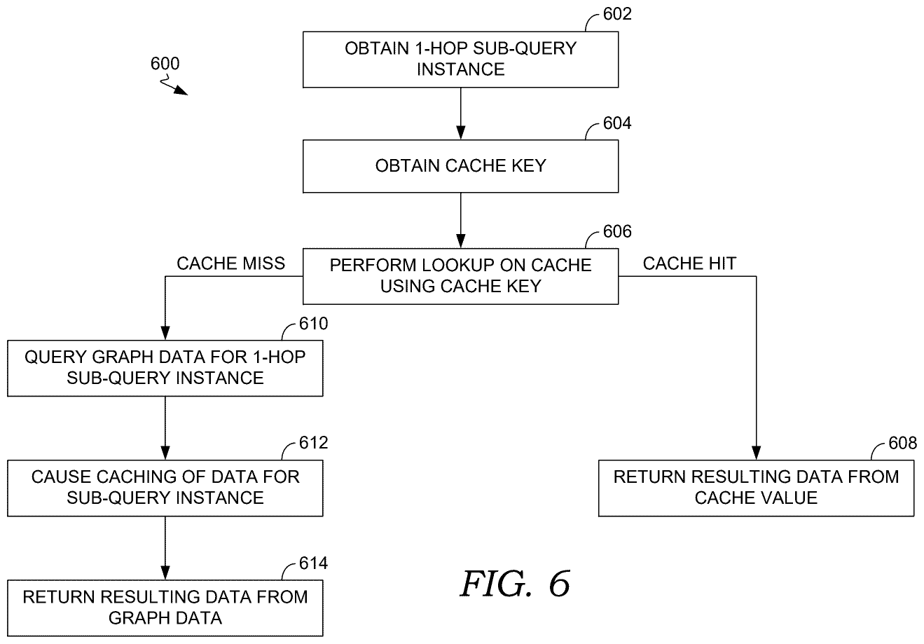

At block 506, each sub-query is processed based on the sequence. For some sub-queries, this may involve querying graph data (e.g., the graph data in graph data store 116 of FIG. 1). For any sub-queries corresponding to a 1-hop sub-query instances, the sub-query is processed by leveraging cache data (e.g., the cache data in cache data store 118 of FIG. 1), for instance, using the method 600 described below with reference to FIG. 6. Processing a sequence of sub-queries can involve passing the results from one sub-query to a subsequent sub-query in the sequence. For instance, a sub-query could return a set of vertex identifiers, which are used to process the next sub-query in the sequence. Once all sub-queries have been processed, an output is provided as a response to the graph query, as shown at block 508.

FIG. 6 provides a flow diagram showing a method 600 for processing a 1-hop sub-query instance from a graph query. The method 600 can be performed, for instance, by the query component 110 of FIG. 1. As shown at block 602, a 1-hop sub-query instance is obtained. In some configurations, this may involve determining if the 1-hop sub-query instance matches a sub-query template. In such configurations, 1-hop sub-query instances that don't match a sub-query template may be executed on the graph data without checking the cache.

At block 604, a cache key is generated for the 1-hop sub-query instance based on a root vertex identifier from the sub-query instance. In some cases, the cache key can also be generated using other parameters based, such as a sub-query template identifier, vertex labels/properties, and edge labels/properties, depending on the structure of the 1-hop sub-query instance. A lookup is performed on cache data (e.g., the cache data in the cache data store 118 of FIG. 1) using the cache key, as shown at block 606. The cache data includes cache entries that are key-value pairs, where the value for each key can be a set of vertex identifiers from a 1-hop sub-query instance.

If the lookup results in a cache hit (i.e., the cache key is present in the cache data), data is returned from the cache entry with the cache key, as shown at block 608. This could include deserializing and/or decompressing the value from the cache entry. The data can comprise a set of leaf vertex identifiers that can be passed to a next sub-query, if applicable.

Alternatively, if the lookup results in a cache miss (i.e., the cache key is missing from the cache data), the graph data is queried for the 1-hop sub-query instance, as shown at block 610. Additionally, the process causes caching of the 1-hop sub-query instance, as shown at block 612. In some configuration, this could involve synchronous caching in which the data returned from the graph data at block 610 is cached. In other configurations, asynchronous caching is used, such that the process at block 612 involves adding the 1-hop sub-query instance to a cache queue. The data from querying the graph data is returned, as shown at block 614. The data can comprise a set of leaf vertex identifiers that can be passed to a next sub-query, if applicable.

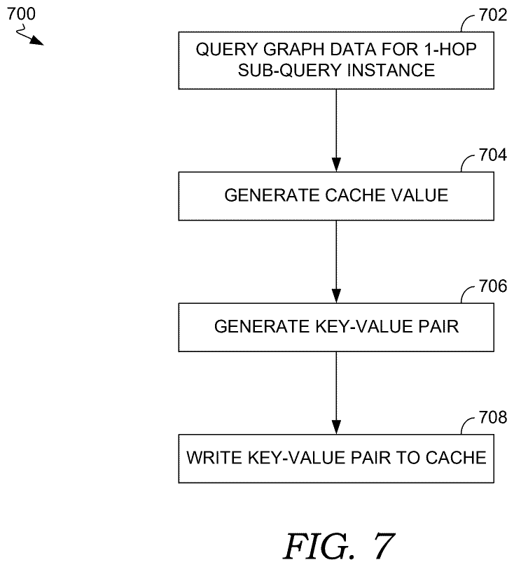

Turning next to FIG. 7, a flow diagram is provided showing a method 700 for adding a cache entry for a 1-hop sub-query instance to cache data. The method 700 can be performed, for instance, by the cache component 112 of FIG. 1. As shown at block 702, the sub-query instance is processed by querying the graph data. A cache value is generated using the data returned from the graph data, as shown at block 704. For instance, the data returned may comprise a set of vertex identifiers, and the cache value could be generated by serializing and/or compressing the vertex identifiers.

As shown at block 706, a key-value pair is generated that includes a cache key for the sub-query instance and the value generated at block 704. In some instances, the cache key was previously generated and provided to the process. In other instances, the cache key is generated as part of the method 700. The key-value pair is added to the cache data as a cache entry, as shown at block 708.

In some aspects, the method 700 is performed as a transaction. In such configurations, the transaction starts at the beginning of the method 700 and is completed when the cache entry is committed to the cache data.

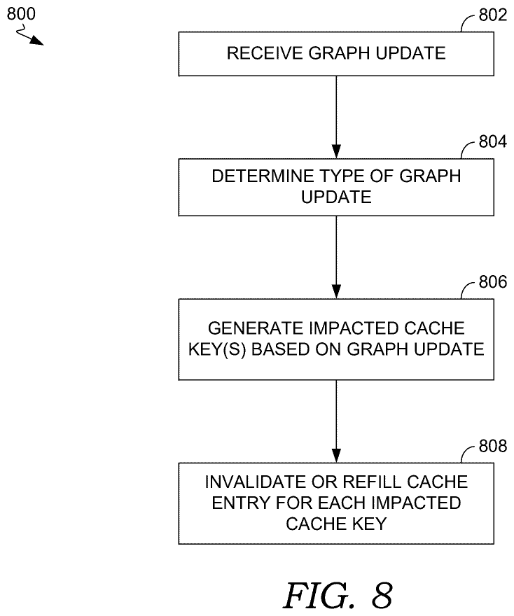

With reference next to FIG. 8, a flow diagram is provided that shows a method 800 for updating cache data based on a graph update. The method 800 can be performed, for instance, by the update component 114 of FIG. 1. As shown at block 802, a graph update is received. The type of the graph update is determined at block 804. For instance, the graph update could include one or more of the following: adding a new edge between two vertices; deleting an edge between two vertices; adding a property value to an edge between two vertices; deleting a property from an edge between two vertices; updating a property value of an edge between two vertices; adding a new property with a value to vertex; deleting a property and its value from vertex; updating a property value of vertex; deleting a vertex; and adding a vertex.

One or more impacted cache keys are generated based on the graph update, as shown at block 806. In the current method, the impacted cache keys can be generated based on the graph update type. A modification is made to the cache entry for each impacted cache key, as shown at block 808. The modification to the cache entry could comprise an invalidate or refill.

In some aspects, the method 800 is performed as a transaction that starts at the beginning of the method and is completed when the modification is committed. In some aspects, the modification of the cache data is performed as a transaction in conjunction with modifying the graph data based on the graph update, in order to maintain consistency.

### Exemplary Operating Environment

Having described implementations of the present disclosure, an exemplary operating environment in which embodiments of the present technology can be implemented is described below in order to provide a general context for various aspects of the present disclosure. Referring initially to FIG. 9 in particular, an exemplary operating environment for implementing embodiments of the present technology is shown and designated generally as computing device 900. Computing device 900 is but one example of a suitable computing environment and is not intended to suggest any limitation as to the scope of use or functionality of the technology. Neither should the computing device 900 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 9, computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what can be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 9 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. The memory can be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which can be built in. Illustrative components include a microphone, joystick, game pad, satellite dish, scanner, printer, wireless device, etc. The I/O components 920 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 900. The computing device 900 can be equipped with depth cameras, such as, stereoscopic camera systems, infrared camera systems, RGB camera systems, and combinations of these for gesture detection and recognition. Additionally, the computing device 900 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the words “accessing” and “obtaining” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” also includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
obtaining a 1-hop sub-query instance corresponding to a 1-hop graph traversal from a vertex in a graph database, wherein the 1-hop sub-query instance includes a predicate on an edge property or a leaf vertex property;
generating a cache key using a vertex identifier for the vertex from the 1-hop sub-query instance and a property value from the predicate;
performing a lookup in cache data using the cache key, the cache data comprising cache entries, each cache entry comprising a key-value pair;
responsive to identifying a cache entry having the cache key, obtaining one or more leaf vertex identifiers from a value of the cache entry; and
providing an output using the one or more leaf vertex identifiers.

2. The one or more computer storage media of claim 1, wherein the operations further comprise:
receiving a graph query;
analyzing the graph query to identify a sequence of sub-queries; and
identifying the 1-hop sub-query instance based on a first sub-query from the sequence of sub-queries.

3. The one or more computer storage media of claim 2, wherein the 1-hop sub-query instance is identified by determining the first sub-query matches a first sub-query template from a plurality of sub-query templates.

4. The one or more computer storage media of claim 3, wherein the cache key is generated using a sub-query template identifier for the first sub-query template.

5. The one or more computer storage media of claim 4, wherein a plurality of leaf vertex identifiers are obtained based on the value of the cache entry, and wherein the operations further comprise:
obtaining a plurality of subsequent 1-hop sub-query instances using the plurality of leaf vertex identifiers and a second sub-query from the sequence of sub-queries;
obtaining, from the cache data and/or graph data from the graph database, a set of one or more leaf vertex identifiers for each subsequent 1-hop sub-query instance; and
wherein the output is generated using a combined set of leaf vertex identifiers provided by combining the set of one or more leaf vertex identifiers for each of the plurality of subsequent 1-hop sub-query instances.

6. The one or more computer storage media of claim 5, wherein obtaining a first set of one or more leaf vertex identifiers for a first subsequent 1-hop sub-query instance comprises:
generating a second cache key for the first subsequent 1-hop sub-query instance using a second vertex identifier for a second vertex from the first subsequent 1-hop sub-query instance, the second vertex comprising a leaf vertex identifier from the plurality of leaf vertex identifiers;
performing a lookup in the cache data using the second cache key for the first subsequent 1-hop sub-query instance; and
responsive to not identifying a second cache entry having the second cache key, querying the graph data to obtain the first set of one or more leaf vertex identifiers for the first subsequent 1-hop sub-query instance.

7. The one or more computer storage media of claim 1, wherein obtaining the one or more leaf vertex identifiers from the value of the cache entry comprises deserializing and/or decompressing the value to obtain the one or more leaf vertex identifiers.

8. A computer-implemented method comprising:
obtaining a 1-hop sub-query instance corresponding to a 1-hop graph traversal from a vertex in a graph database that includes a predicate on an edge property or a leaf vertex property;
obtaining a cache key using a vertex identifier for the vertex from the 1-hop sub-query instance and a property value from the predicate;
querying graph data in a graph database using the 1-hop sub-query instance to obtain one or more leaf vertex identifiers;
generating a value using the one or more leaf vertex identifiers; and
storing a key-value pair as a cache entry in cache data for the graph database using the cache key and the value.

9. The computer-implemented method of claim 8, wherein the method is performed by the graph database as a single transaction.

10. The computer-implemented method of claim 8, wherein the 1-hop sub-query instance is obtained in response to a cache miss on the cache data for the 1-hop sub-query instance when processing a graph query.

11. The computer-implemented method of claim 10, wherein the method is performed asynchronously from processing the graph query.

12. The computer-implemented method of claim 8, wherein the 1-hop sub-query instance is obtained using a sub-query template and the vertex identifier.

13. The computer-implemented method of claim 12, wherein the sub-query template comprises a predicate with a placeholder for a property of an edge or a leaf vertex, and wherein the 1-hop sub-query instance is obtained by replacing the placeholder with a property value for the property, and wherein the cache key is generated using the property value.

14. The computer-implemented method of claim 8, wherein the 1-hop sub-query instance is obtained by analyzing historical query information for the graph database.

15. A computer system comprising:
a processor; and
a computer storage medium storing computer-useable instructions that, when used by the processor, causes the computer system to perform operations comprising:
receiving a graph update for a graph database;
generating one or more impacted cache keys based on the graph update; and
modifying a cache entry for each impacted cache key, each cache entry comprising a key-value pair for a 1-hop sub-query instance corresponding to a 1-hop graph traversal of graph data in the graph database.

16. The computer system of claim 15, wherein the graph update comprises one or more selected from the following: adding an edge, changing a property of an edge, deleting an edge, adding a vertex, changing a property of a vertex, and deleting a vertex.

17. The computer system of claim 15, wherein at least one impacted cache key is generated using a vertex identifier for a vertex impacted by the graph update.

18. The computer system of claim 15, wherein modifying a first cache entry for a first impacted cache key comprises invalidating the first cache entry or refilling a value of the first cache entry based on the graph update.

19. The computer system of claim 15, wherein the operations and one or more modifications to graph data in the graph database based on the graph update are performed by the graph database as a write transaction.

20. The computer system of claim 15, wherein the operations further comprise:
determining a graph update type for the graph update; and
wherein the one or more impacted cache keys are generated based and the graph update type.
